(19) United States
(12) Patent Application Publication
(10) Pub. No.: US 2026/0131413 A1
(43) Pub. Date: May 14, 2026

(54) THERMAL DISTORTION IN MACHINE TOOLS

(71) Applicant: FIVES LANDIS LIMITED, Keighley Yorkshire (GB)

(72) Inventor: Mark STOCKER, Bedford Bedfordshire (GB)

(21) Appl. No.: 19/105,273

(22) PCT Filed: Aug. 22, 2023
(86) PCT No.: PCT/GB2023/052181

§ 371 Date: Feb. 20, 2025

(30) Foreign Application Priority Data
Aug. 26, 2022 (GB) 2212420.0

(51) Int. Cl. B23Q 11/00; B23Q 1/52; G05B 19/404

(52) U.S. Cl. CPC B23Q 11/0007; B23Q 1/522; G05B 19/404; G05B 2219/49169; G05B 2219/49207

(57) ABSTRACT

A machine tool comprises two parallel and spaced apart rotational machine axes (32, 5 34), and at least one linear distortion sensor (78). The sensor is arranged to detect a change in the distance between a first pair of reference points on the machine base which lie on a first reference line, and to detect a change in the distance between a second pair of reference points on the machine base which lie on a second reference line. The axes of rotation (36, 38) of the machine axes lie in a longitudinal reference plane. The first and second reference lines are transverse with respect to the first and second axes of rotation, and are spaced apart along the direction of the first and second axes of rotation, and the first and second pairs of reference points are located on and spaced from the same side of the longitudinal reference plane.

### FIELD OF THE DISCLOSURE

The present disclosure relates to thermal distortion of machine tools and, more particularly, it concerns measurement of and compensation for such distortion.

### BACKGROUND TO THE DISCLOSURE

In high precision machining operations, thermal effects are becoming dominant sources of machining errors.

In typical machine tools which include multiple linear machine axes mounted on a machine bed, it can be difficult to accurately measure and compensate for distortions caused by localised heating of regions of the machine.

By way of illustration, FIG. 1 shows the results of a simulation of a known grinding machine 2. A workpiece 4 is rotatably mounted between a headstock 6 and a tailstock 8. A grinding wheel 10 is mounted on a drive spindle 12. The drive spindle is supported on linear guideways 14 to facilitate linear motion of the drive spindle along a direction parallel with the longitudinal axis 16 of the workpiece. In FIG. 1, the grinding wheel drive spindle is shown in two different locations 12 and 12′ along its guideways (with the spindle at location 12′ carrying a grinding wheel 10′), towards opposite ends of its range of travel along the guideways.

The temperature of different regions of the machine tool of FIG. 1 is represented graphically, with the darkness of the shading increasing with temperature. The distortion of the shape of the machine tool due to localised heating and expansion is exaggerated in FIG. 1 for the purposes of illustration.

The temperature distribution shown in FIG. 1 represents a scenario in which the grinding wheel at location 10′ has been machining the workpiece and is inputting heat into the region identified by oval 18. At the other end of the range of travel of the drive spindle, the machine bed has cooled down after being heated when the grinding was previously taking place in the region marked by oval 20 using the grinding wheel at location 10.

The continuous heating and cooling of different regions of a conventional machine tool bed during a machining operation leads to significant machine distortions in different directions that can cause many tens of microns of undesired motion between the tool and the workpiece. The effects of these distortions are complex and vary with location in the machine, and the distortions are likely to involve both bending and twisting of the machine bed. Often such machines use multiple linear machine axes which extend in orthogonal directions and may be stacked one on top of another.

These configurations further increase the asymmetry of the machine and the complexity and extent of thermal distortions.

These factors make it difficult to predict, measure and compensate for thermal distortion of the machine bed in these machines. There have been attempts to compensate for thermal distortion in conventional machine tools by mounting temperature sensors on a machine bed in order to measure temperature differentials and then adjust for resulting errors in the locations of a tool and workpiece. However, such methods have been found to be too difficult to be implemented with sufficient accuracy in practice.

### SUMMARY OF THE DISCLOSURE

The present disclosure provides a machine tool for machining a workpiece, the machine tool comprising:
a machine base;
a first support provided by a first rotational machine axis, the first rotational machine axis being rigidly mounted on the base in an immovably fixed position relative to the base and comprising a first drive operable to rotate the first support about a first axis of rotation;
a second support provided by a second rotational machine axis, the second rotational machine axis being rigidly mounted on the base in an immovably fixed position relative to the base and comprising a second drive operable to rotate the second support about a second axis of rotation, wherein the second axis of rotation of the second rotational machine axis is parallel to and spaced laterally from the first axis of rotation of the first rotational machine axis, and the first and second axes of rotation lie in a longitudinal reference plane; and
at least one linear distortion sensor arranged to detect a change in the distance between a first pair of reference points on the machine base which lie on a first reference line, and to detect a change in the distance between a second pair of reference points on the machine base which lie on a second reference line,
wherein the first and second reference lines are transverse with respect to the first and second axes of rotation and are spaced apart along the direction of the first and second axes of rotation, and the first and second pairs of reference points are located on and spaced from the same side of the longitudinal reference plane.

The present inventors realised that this form of machine configuration tends to distort in less complex, more readily measurable ways in comparison to a machine tool using multiple linear axes mounted on a machine base to move a tool and workpiece relative to each other. This is because the machine configuration described above employs driven rotational machine axes which rotate about axes that are at unadjustably fixed locations in relation to the machine bed. In preferred implementations, the two rotational machine axes may be the only driven machine axes mounted directly onto the machine bed. It was determined that the at least one distortion sensor configured as described above may alone be sufficient to detect primary distortions occurring in such a machine configuration during a machining operation. The at least one sensor is able to give a measure of these distortions which can then be effectively compensated for.

In a preferred example, the machine tool includes:
the at least one linear distortion sensor is arranged to detect a change in the distance between a third pair of reference points on the machine base which lie on a third reference line, and to detect a change in the distance between a fourth pair of reference points on the machine base which lie on a fourth reference line,
wherein the third and fourth reference lines are transverse with respect to the first and second axes of rotation and are spaced apart along the direction of the first and second axes of rotation, and the third and fourth pairs of reference points are spaced from the opposite side of the longitudinal reference plane to the first and second pairs of reference points.

Provision of pairs of reference points on opposite sides of the machine base in this manner facilitates measurement of distortions with greater accuracy, and allows different components of the distortion to be detected. These pairs alone may enable detection of displacement of the axes of rotation relative to each other about all three degrees of freedom of rotation.

The machine tool may include:
a controller for controlling the first and second drives and arranged to receive signals from the at least one linear distortion sensor and adjust control signals sent to the first and second drives during a machining operation in response to the signals from the at least one linear distortion sensor so as to compensate for distortion of the machine base.

Thus, distortion compensation may be integrated into the machine's controller so that position error corrections can be incorporated into control signals sent to the drives of the machine which govern the location of the components carried by each rotational machine axis and brought into contact by the drives of the machine (these components may be a tool such as a grinding wheel and a workpiece, for example).

The reference lines may be perpendicular to the first and second axes of rotation. Preferably, the reference lines are parallel to each other. The reference lines may extend parallel to the longitudinal reference plane of the machine tool.

The at least one linear distortion sensor may be mounted on the machine base. Alternatively, the location of reference points on the machine base may be detected using at least one sensor mounted elsewhere on the machine tool or using at least one separate device which may be remote from the machine tool.

The linear distortion sensor is a device arranged to detect a change in the distance between a pair of points. It may take measurements by which, or generate signals from which, such a distance change can be calculated. The sensor may comprise an electronic location sensor for sensing the location of a point in space or an electronic displacement sensor for sensing displacement of one point relative to another, for example.

In some examples, the linear distortion sensor may include a light source, such as a source of laser light. It may be able to determine the location in space of a reference point by detecting light reflected back directly from the reference point. Such an arrangement could be implemented using an RLD10 plane mirror interferometer marketed by Renishaw, for example.

The distortion sensor may be used in combination with a trackable device which may comprise a reflector or light sensor. The distortion sensor may be configured to determine the location of a trackable device mounted at a selected point on a machine axis and record the location. Laser tracker systems are marketed for example by Hexagon Manufacturing Intelligence and Faro.

The distortion sensor may include a contact probe and be able to detect the location in space of a reference point on a machine base when the contact probe is brought into contact with the point. The sensor may include an articulated arm on which the contact probe is mounted. Examples of suitable measurement arms are marketed by Nikon, Trimos, Faro and Hexagon Manufacturing Intelligence.

In further preferred examples, the first and second axes of rotation lie in first and second reference planes, respectively, which are mutually parallel and perpendicular to the longitudinal reference plane, and one of each pair of reference points lies in one of the first and second reference planes and the other of each pair of reference points lies in the other of the first and second reference planes. Accordingly, the locations of the reference points are aligned with the axes of rotation and therefore facilitate precise measurement of displacements thereof.

Each linear distortion sensor may comprise a rod with one end fixed relative to one of the respective pair of reference points and a transducer arranged to generate an output signal in response to movement of the other end of the rod relative to the other of the respective pair of reference points. Alternatively, the or each linear distortion sensor may take other forms, such as linear encoders, laser-based measurement systems or Bragg grating-based distortion detection techniques (in which distortion of the grating changes the wavelength of light reflected by the grating), for example.

The present disclosure further provides a method of compensating for distortion of the machine base of a machine tool of the form at which this disclosure is directed, comprising the steps of:
(a) receiving signals from the at least one linear distortion sensor; and
(b) adjusting control signals sent to the first and second drives during a machining operation in response to the signals from the at least one linear distortion sensor so as to compensate for distortion of the machine base.

The present disclosure also provides a method for detecting distortion of the machine base of a machine tool for machining a workpiece, the machine tool comprising:
a machine base;
a first support provided by a first rotational machine axis, the first rotational machine axis being rigidly mounted on the base in an immovably fixed position relative to the base and comprising a first drive operable to rotate the first support about a first axis of rotation; and
a second support provided by a second rotational machine axis, the second rotational machine axis being rigidly mounted on the base in an immovably fixed position relative to the base and comprising a second drive operable to rotate the second support about a second axis of rotation, wherein the second axis of rotation of the second rotational machine axis is parallel to and spaced laterally from the first axis of rotation of the first rotational machine axis, and the first and second axes of rotation lie in a longitudinal reference plane,
wherein the method comprises the steps of:
detecting a change in the distance between a first pair of reference points on the machine base which lie on a first reference line with at least one linear distortion sensor; and
detecting a change in the distance between a second pair of reference points on the machine base which lie on a second reference line with the at least one linear distortion sensor,
the first and second reference lines are transverse with respect to the first and second axes of rotation, and are spaced apart along the direction of the first and second axes of rotation, and the first and second pairs of reference points are located on and spaced from the same side of the longitudinal reference plane.

The at least one electronic linear distortion sensor may then determine, or generate an output signal which can be used by an electronic processor to determine, changes in the distances between the pairs of reference points. These changes may then be used by another (or the) electronic processor to calculate the distortion of the machine base and enable compensation for the calculated distortion to be implemented.

### BRIEF DESCRIPTION OF THE DRAWINGS

Existing machine tool configurations and an example of the present disclosure are described herein with reference to the accompanying schematic drawings, wherein:

FIG. 1 is an image illustrating thermal distortion of a conventional linear axis-based machine tool;

FIGS. 2 and 3 are perspective views of a twin rotary axis machine tool;

FIG. 4 is an image illustrating thermal distortion of a machine bed of a twin rotary axis machine tool; and

FIG. 5 is a perspective view of a twin rotary axis machine tool including a pair of linear distortion sensors.

### DETAILED DESCRIPTION

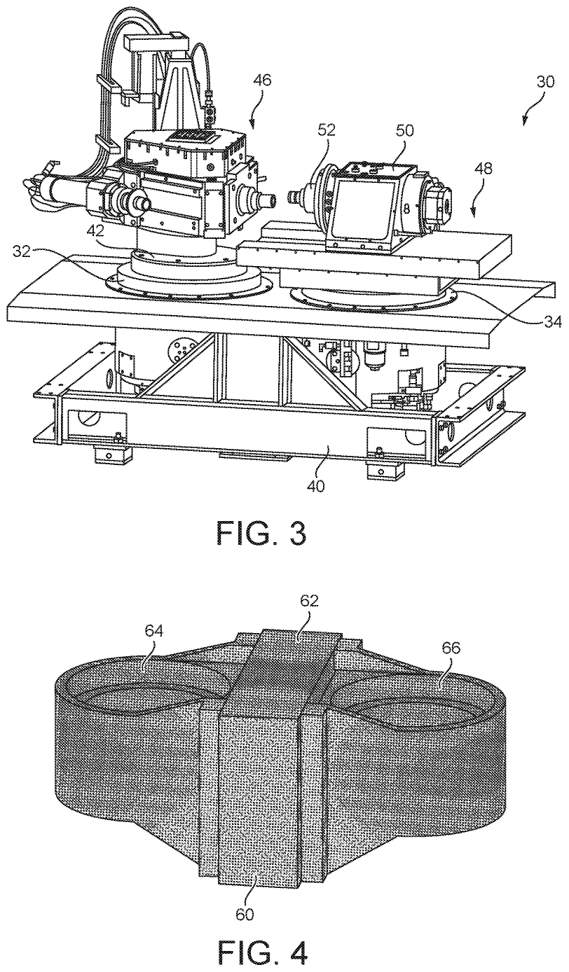

FIGS. 2 and 3 show an example of a machine tool 30 at which the present disclosure is directed. A machine tool of this form is disclosed in GB-A-2456843.

The machine's primary driven axes are two rotational machine axes 32 and 34 having mutually parallel respective axes of rotation 36 and 38. In FIG. 2, the machine tool is shown with upper components removed so that the rotational machine axes are more clearly visible. The two rotational machine axes 32 and 34 are mounted at fixed locations on a machine base 40, such that the spacing between their axes of rotation is fixed.

In the example shown in FIG. 3, further components have been mounted on the rotational machine axes. These components are usually temperature-controlled using hydrostatic oil, motor cooling water and grinding coolant. The first rotational machine axis 32 provides a first support 42 onto which a turret 44 is mounted in FIG. 3. The turret carries a number of tools and gauges for selectively bringing into engagement with a workpiece. The second rotational axis 34 provides a second support 46 onto which a driven linear machine axis 48 is mounted in FIG. 3. The linear machine axis in turn carries a workpiece drive spindle 50. The drive spindle includes a chuck 52 for receiving a workpiece to be machined.

The machine tool of FIGS. 2 and 3 includes a control arrangement operable to control the orientation of the first support 42 of the first rotational machine axis 32, the orientation of the second support 46 of the second rotational machine axis 34 (to govern the orientation of the workpiece drive spindle 50 relative to the second axis of rotation 38) and the location of the drive spindle 50 along the linear machine axis 48, so as to determine the position and orientation of the first support and the workpiece drive spindle relative to each other.

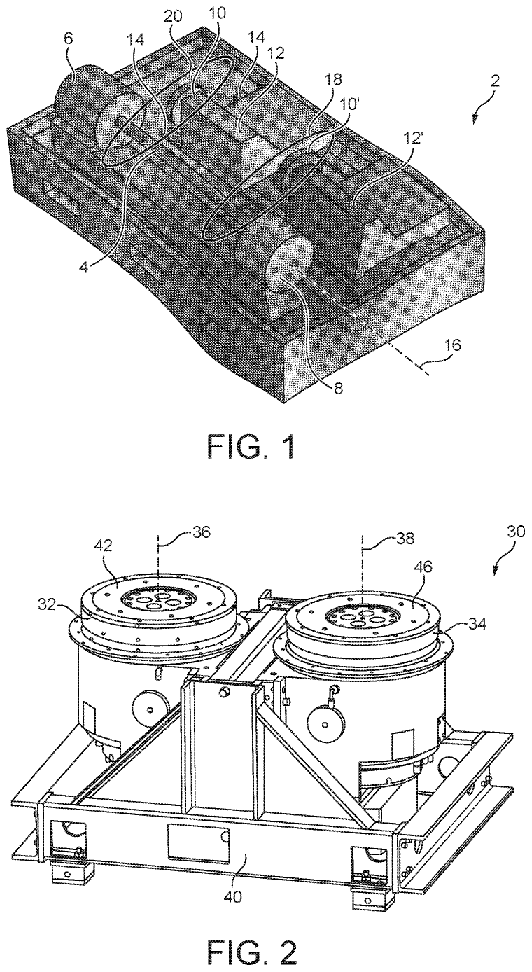

It has been determined that, in machine tools having two primary rotational machine axes mounted in fixed positions relative to the machine base, the heating of the machine bed during a machining operation is primarily caused by heat emitted from the drive motors of the rotational machine axes. This occurs at fixed locations in the machine bed and tends to be symmetrical, which in turn leads to relatively simple distortions of the machine bed. This is in marked contrast to distortion of a conventional linear axis-based machine tool of the form shown in FIG. 1 where heating is likely to take place at different locations in an asymmetrical manner, leading to complex distortions.

FIG. 4 shows the result of a simulation of the effect of heating a machine bed 60 of a machine tool which the present disclosure is directed. Darker shading indicates a higher temperature. The machine bed includes a central, vertical slab 62. The bed also defines two cylindrical openings 64 and 66 on opposite sides of the slab 62 for receiving respective rotational machine axes with their axes of rotation parallel in the assembled machine. It can be seen that the effect of heating by the motors of the two rotational machine axes is largely symmetrical relative to a plane located midway between their axes of rotation.

It was realised that these are the primary distortions occurring in such a machine tool and that they could be reliably measured and compensated for in practice.

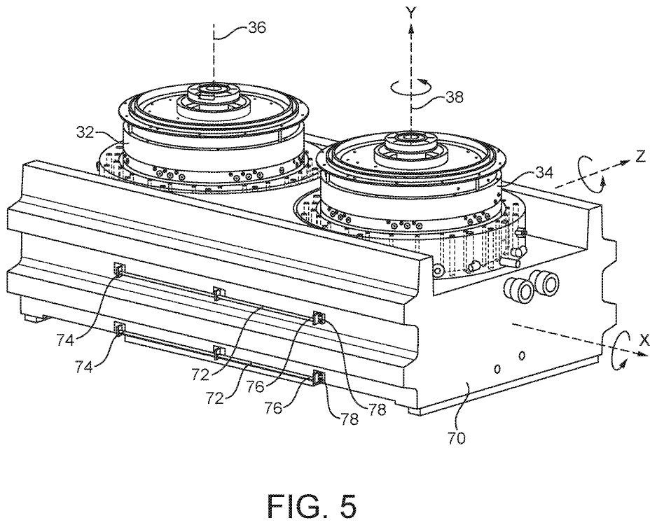

FIG. 5 shows a machine base 70 of a machine tool of the type at which the present disclosure is directed. Two rotational machine axes 32 and 34 are mounted in the machine base. The machine base is in the form of a horizontal, generally solid slab which supports the rotational machine axes.

Four rods or spars formed of a low thermal expansion material (such as invar) are mounted on the machine bed. Two spars 72 are mounted on one side of the bed, with the other two spars mounted on the opposite side. Each spar is clamped in a fixed position on the machine bed at one end 74, whilst the opposite ends 76 are supported but free to move axially relative to the machine bed. This movement is measured using respective transducers 78 mounted to the bed.

The pair of spars 72 on each side of the machine bed extend parallel to each other, along a direction perpendicular to the axes of rotation 36 and 38 of the rotational machine axes. The spars extend parallel to a longitudinal reference plane of the machine base which includes the axes of rotation. Each pair of spars is spaced apart along the direction of the first and second axes of rotation. It is preferable to make this spacing as large as practicable so as to increase the difference between the distortions detected by each spar, leading to more accurate measurement of distortions.

By monitoring the four distances measured by the distortion sensors, bending of the machine bed and resulting changes in the separation of the rotational machine axes can be determined.

The ends of the spars are preferably aligned in the direction extending along their lengths with the locations of the axes of rotation of the two rotational machine axes. As a result, the motions of their ends closely correspond to the movement of the respective axes due to any distortion of the machine bed.

The transducers 78 generate signals which can then be used to determine the distortion of the machine bed, which can then be compensated for. For example, control signals sent to the two rotational machine axes and other driven components which govern the relative positions of the workpiece and tool can be adjusted in response to the signals from the transducers so as to counteract the effects of distortion of the machine bed.

Each transducer may be in the form of a Linear Variable Differential Transformer (LVDT), or a capacitance or eddy current-based movement sensor, for example.

It will be appreciated that distortion of the machine bed may cause displacement of each axis of rotation having rotational components about three mutually perpendicular reference axes. As illustrated in FIG. 5, these components are roll motion about a horizontal, longitudinal axis “X” which passes through both of the axes of rotation 36 and 38, pitch motion about a horizontal axis “Z” which is perpendicular to the “X” axis, and yaw motion about a vertical axis “Y”. Use of two linear distortion sensors located on one side of the machine bed (as in the case of the spars 72 visible in FIG. 5) enables detection of pitching motion of the axes of rotation. The deployment of four linear distortion sensors, with a pair on opposite sides of the machine bed, facilitates detection of all three components of displacement of each axis of rotation. This can be used to calculate the resulting errors in position between the tool and workpiece. The machine controller then adjusts control signals sent to the driven machine axes in order to compensate for these errors.

1. A machine tool for machining a workpiece, the machine tool comprising:
a machine base;
a first support provided by a first rotational machine axis, the first rotational machine axis being rigidly mounted on the base in an immovably fixed position relative to the base and comprising a first drive operable to rotate the first support about a first axis of rotation;
a second support provided by a second rotational machine axis, the second rotational machine axis being rigidly mounted on the base in an immovably fixed position relative to the base and comprising a second drive operable to rotate the second support about a second axis of rotation, wherein the second axis of rotation of the second rotational machine axis is parallel to and spaced laterally from the first axis of rotation of the first rotational machine axis, and the first and second axes of rotation lie in a longitudinal reference plane; and
at least one linear distortion sensor arranged to detect a change in the distance between a first pair of reference points on the machine base which lie on a first reference line, and to detect a change in the distance between a second pair of reference points on the machine base which lie on a second reference line,
wherein the first and second reference lines are transverse with respect to the first and second axes of rotation, and are spaced apart along the direction of the first and second axes of rotation, and the first and second pairs of reference points are located on and spaced from the same side of the longitudinal reference plane.

2. A machine tool of claim 1, wherein:
the at least one linear distortion sensor is arranged to detect a change in the distance between a third pair of reference points on the machine base which lie on a third reference line, and to detect a change in the distance between a fourth pair of reference points on the machine base which lie on a fourth reference line,
wherein the third and fourth reference lines are transverse with respect to the first and second axes of rotation and are spaced apart along the direction of the first and second axes of rotation, and the third and fourth pairs of reference points are spaced from the opposite side of the longitudinal reference plane to the first and second pairs of reference points.

3. A method of detecting distortion of the machine base of a machine tool for machining a workpiece, the machine tool comprising:
a machine base;
a first support provided by a first rotational machine axis, the first rotational machine axis being rigidly mounted on the base in an immovably fixed position relative to the base and comprising a first drive operable to rotate the first support about a first axis of rotation; and
a second support provided by a second rotational machine axis, the second rotational machine axis being rigidly mounted on the base in an immovably fixed position relative to the base and comprising a second drive operable to rotate the second support about a second axis of rotation, wherein the second axis of rotation of the second rotational machine axis is parallel to and spaced laterally from the first axis of rotation of the first rotational machine axis, and the first and second axes of rotation lie in a longitudinal reference plane,
wherein the method comprises the steps of:
detecting a change in the distance between a first pair of reference points on the machine base which lie on a first reference line with at least one linear distortion sensor; and
detecting a change in the distance between a second pair of reference points on the machine base which lie on a second reference line with the at least one linear distortion sensor,
the first and second reference lines are transverse with respect to the first and second axes of rotation, and are spaced apart along the direction of the first and second axes of rotation, and the first and second pairs of reference points are located on and spaced from the same side of the longitudinal reference plane.

4. A method of claim 3 including the steps of:
detecting a change in the distance between a third pair of reference points on the machine base which lie on a third reference line with the at least one linear distortion sensor; and
detecting a change in the distance between a fourth pair of reference points on the machine base which lie on a fourth reference line with the at least one linear distortion sensor,
wherein the third and fourth reference lines are transverse with respect to the first and second axes of rotation and are spaced apart along the direction of the first and second axes of rotation, and the third and fourth pairs of reference points are spaced from the opposite side of the longitudinal reference plane to the first and second pairs of reference points.

5. A machine tool of claim 1, wherein the machine tool includes:
a controller for controlling the first and second drives and arranged to receive signals from the at least one linear distortion sensor and adjust control signals sent to the first and second drives during a machining operation in response to the signals from the at least one linear distortion sensor so as to compensate for distortion of the machine base.

6. A machine tool of claim 1, wherein the reference lines are perpendicular to the first and second axes of rotation.

7. A machine tool of claim 1, wherein the reference lines are parallel to each other.

8. A machine tool of claim 1, wherein the at least one linear distortion sensor is mounted on the machine base.

9. A machine tool of claim 1, wherein the first and second axes of rotation lie in first and second reference planes, respectively, which are mutually parallel and perpendicular to the longitudinal reference plane, and one of each pair of reference points lies in one of the first and second reference planes and the other of each pair of reference points lies in the other of the first and second reference planes.

10. A machine tool of claim 1, wherein each linear distortion sensor comprises a rod with one end fixed relative to one of the respective pair of reference points and a transducer arranged to generate an output signal in response to movement of the other end of the rod relative to the other of the respective pair of reference points.

11. A method of compensating for distortion of the machine base of a machine tool of claim 1, comprising the steps of:
(a) receiving signals from the at least one linear distortion sensor; and
(b) adjusting control signals sent to the first and second drives during a machining operation in response to the signals from the at least one linear distortion sensor so as to compensate for distortion of the machine base.
